(19) United States
(12) Patent Application Publication
(10) Pub. No.: US 2020/0088077 A1
(43) Pub. Date: Mar. 19, 2020

(54) SILENCER FOR AN EXHAUST GAS SYSTEM OF A MOTOR VEHICLE AND MOTOR VEHICLE WITH A SILENCER

(71) Applicant: Faurecia Emissions Control Technologies, Germany GmbH, Augsburg (DE)

(72) Inventors: Boris Kienle, Augsburg (DE); Hans Peter Fiessinger, Augsburg (DE); Klaus Regenold, Augsburg (DE); André Lungfiel, Augsburg (DE)

(21) Appl. No.: 16/571,420

(22) Filed: Sep. 16, 2019

(30) Foreign Application Priority Data
Sep. 17, 2018 (DE) 10 2018 122 637.3

(51) Int. Cl. F01N 1/00; F01N 3/021; F01N 3/022; B01D 46/24; B01D 46/42; F01N 1/24; B01D 46/00

(52) U.S. Cl. CPC F01N 1/006; F01N 3/0211; F01N 3/0222; B01D 46/2422; B01D 46/4236; B01D 2279/30; B01D 46/0012; F01N 2470/02; F01N 2490/15; F01N 2230/02; F01N 1/24

(57) ABSTRACT

A silencer for an exhaust gas system of a motor vehicle has an external housing that has at least one inlet opening and at least one outlet opening for exhaust gas. The silencer includes a silencer chamber and a filter monolith through which exhaust gas flows, and which is circumferentially surrounded by the silencer chamber. Also disclosed is a motor vehicle with at least one silencer.

### CROSS-REFERENCE TO RELATED APPLICATIONS

This application is a U.S. non-provisional application claiming the benefit of German Application No. 10 2018 122 637.3, filed on Sep. 17, 2018, which is incorporated herein by its entirety.

### TECHNICAL FIELD

The invention relates to a silencer for an exhaust gas system of a motor vehicle and a motor vehicle with at least one silencer.

### BACKGROUND

In the exhaust gas system of a motor vehicle, combustion gases which are discharged from the combustion engine are treated in order to reduce emissions. In the process the pollutants are removed from the exhaust gas or converted into different substances by particulate filters and catalytic converters by chemical, catalytic and/or mechanical means.

It is further known to use silencers in an exhaust gas system in order to reduce noise emissions. Silencers are known in various embodiments with different operating principles, for example in the form of reflective, absorptive or resonance silencers.

In the automotive sector, efforts are always being made to improve the efficiency of motor vehicles in all areas, in particular by reducing weight and optimizing the installation space.

### SUMMARY

A silencer for an exhaust gas system of a motor vehicle is provided which has a more compact design of the exhaust gas system.

The silencer comprises an external housing, which has at least one inlet opening and at least one outlet opening for exhaust gas, a silencer chamber, and a filter monolith through which exhaust gas flows, in particular a catalytic converter or particulate filter (DPF, GPF). In the process, the filter monolith is circumferentially surrounded by the silencer chamber, whereby the filter monolith is arranged at least partially within the silencer chamber. In this way, the filter monolith is part of the silencer, wherein the installation space around the filter monolith is provided at least partially for a silencer chamber of the silencer. As a result of this nested design, the required installation space of the exhaust gas system can be reduced by using the disclosed silencer.

According to an embodiment, the filter monolith is arranged fully within the silencer chamber, whereby the silencer and thus the exhaust gas system can be designed particularly compact.

It can be provided that the silencer comprises an upstream end wall having the inlet opening and a downstream end wall having the outlet opening, as well as an outer casing which extends from the upstream end wall to the downstream end wall and connects them. This multi-part design has the advantage that the silencer can be produced cost-effectively.

In the process, the silencer chamber can be delimited on one side by the upstream end wall and/or by the downstream end wall and on the other side by the outer casing, with the result that the size of the silencer chamber can be easily adapted to different requirements, for example to filter monoliths of different sizes, by choosing correspondingly dimensioned end walls and/or a correspondingly dimensioned outer casing.

In order to conduct the exhaust gas in defined manner through the silencer, it is advantageous if a first exhaust gas line extending at least from the inlet opening into the housing interior and/or a second exhaust gas line extending at least in sections from the monolith to the outlet opening are provided, which preferably extend through their allocated end walls.

According to a further embodiment, the silencer chamber is divided into several silencer subchambers, wherein the second exhaust gas line runs through several of the silencer subchambers and in particular is broken into sections. In this way, the silencer subchambers can be suitably coupled to the exhaust gas flowing through the exhaust gas line during operation in order to guarantee a particularly good reduction in the noise emissions.

It can be provided that the second exhaust gas line is open to the silencer chamber via a perforation, whereby a good coupling of the exhaust gas flowing through the exhaust gas line during operation to the silencer chamber and thus a good silencing can be ensured.

In an embodiment, the filter monolith is surrounded circumferentially and on the end by a monolith housing and accommodated in the monolith housing. The inlet opening is directly coupled in terms of flow to the interior of the monolith housing, with the result that exhaust gas first flows into the monolith housing before it reaches the silencer chamber. This means that the exhaust gas flowing into the silencer is first conducted through the filter monolith and only then coupled to the silencer chamber. Thus, the reduction of the noise emission takes place substantially after the clean exhaust gas has left the filter monolith, whereby the exhaust gas has fewer negative influences (e.g. deposits) on the silencer.

In the process, the second exhaust gas line can proceed from the monolith housing and be equipped to conduct the exhaust gas out of the monolith housing to the outlet opening along a defined, short path.

It is advantageous if the monolith housing has an upstream, conical and a downstream, conical end wall, wherein the second exhaust gas line proceeds from the downstream, conical end wall and the downstream, conical end wall has additional openings at a distance from the second exhaust gas line, which open into the silencer chamber. The monolith housing ensures that the monolith is held perfectly in the silencer and the exhaust gas is conducted substantially fully through the filter monolith and thus filtered or treated, while the additional openings in the exhaust gas line guarantee a defined coupling of the exhaust gas to the silencer chamber and thus a good silencing.

In a further embodiment, the silencer chamber is divided by at least one perforated radial partition into silencer subchambers, which act in particular as resonator chambers. The properties of the silencer can hereby be matched more flexibly to its requirements, in particular in connection with the silencing.

In the process, it can be provided that the at least one partition or one of several partitions is attached radially outside to the outer casing of the external housing and radially inside to the monolith housing, in particular to an outer casing of the monolith housing or to an exhaust-gas-side, conical end wall of the monolith housing or to an exhaust gas line which proceeds from the monolith housing and guides gas out of the monolith housing to the outlet opening. The exhaust gas line is in particular the above-named second exhaust gas line. This design has the advantage that the silencer subchambers formed in this way circumferentially surround the monolith housing, with the result that the installation space is utilized effectively. Further, by attaching the partition to the components already present, material and thus weight can be saved. Furthermore, the structural strength of the silencer can hereby be increased.

In order to keep the assembly costs low, it is advantageous if the external housing of the silencer has an outer casing which is composed of several individual segments attached to one another. Here, the individual segments are allocated to the silencer subchambers. In particular, each silencer subchamber has its own individual segment, i.e. this individual segment has its own components.

According to an embodiment, the at least one partition is attached to the outer casing in the area of the attachment of adjacent individual segments, whereby the silencer can be designed very compact.

In this way, all partitions are preferably each securely connected to the corresponding individual segments.

In particular, the corresponding partition can in the process be attached to the adjacent individual segments by the same attachment interface with which the adjacent individual segments are attached to one another, with the result that the attachment interface connects the three components to one another. In this way, the three components can be securely connected to one another with a single attachment interface and in particular in one attachment step, with the result that the number of attachment interfaces or quantity of attachment interfaces as well as the assembly costs are reduced. Examples of this are a weld seam connecting three parts or a flanging of three parts.

According to a further embodiment, an end wall of the external housing is attached radially inside to a conical end wall or to an outer casing of the monolith housing. In this way, no additional connection components are required, whereby material can be saved. Further, a defined position as well as secure attachment of the monolith housing and thus of the filter monolith in the external housing are hereby ensured.

The silencer chamber can be filled with insulating material or be an empty resonator chamber, i.e. be a resonator chamber without insulating material. The silencing properties of the silencer can hereby be matched to different requirements.

During operation, the silencer chamber preferably does not have exhaust gas flowing through it, but acts for example as a resonator.

In an embodiment in which the silencer chamber is divided into silencer subchambers, different silencer subchambers with different functions can be combined in the silencer, in particular silencer subchambers with and without insulating material.

Further, an exemplary embodiment includes a motor vehicle with one or more of the disclosed silencers.

### BRIEF DESCRIPTION OF THE DRAWINGS

Further advantages and features follow from the description below as well as from the attached drawings. There are shown in:

FIG. 1, in a perspective view, a silencer according to the invention according to a first embodiment for a motor vehicle according to the invention,

FIG. 2 a section of the silencer from FIG. 1 in a schematic representation,

FIG. 3, in a perspective view, a section of a silencer according to the invention according to a second embodiment,

FIG. 4 the section of the silencer from FIG. 3 in a schematic representation,

FIG. 5, in a schematic representation, a silencer according to the invention according to a third embodiment,

FIG. 6, in a schematic representation, a silencer according to the invention according to a fourth embodiment, and

FIG. 7, in a schematic representation, a silencer according to the invention according to a fifth embodiment.

### DETAILED DESCRIPTION

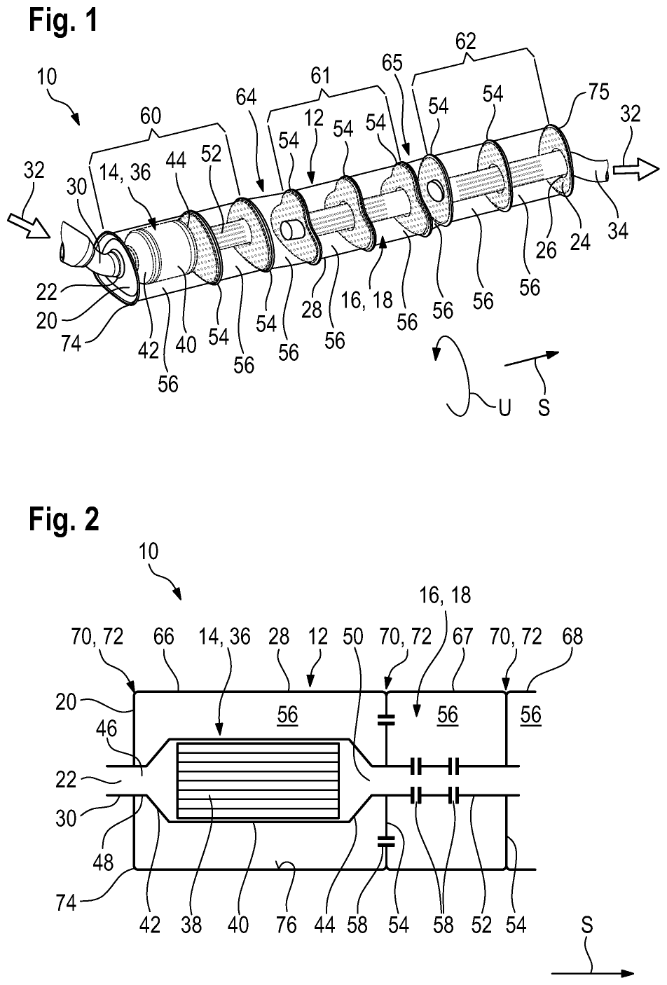

A silencer 10 in an exhaust gas system which is provided for a motor vehicle with a combustion engine is shown in FIG. 1.

The silencer 10 comprises an external housing 12 as well as a filter 14 and a silencer chamber 16, which are arranged in the housing interior 18 of the external housing 12.

The external housing 12 has an upstream end wall 20 with an inlet opening 22, a downstream end wall 24 with an outlet opening 26 as well as an outer casing 28 which extends from the upstream end wall 20 to the downstream end wall 24 and extends along a complete circumference, and seals the external housing 12 radially to the outside.

The silencer 10 is coupled to an inlet pipe 30 of the exhaust gas system via the inlet opening 22, with the result that when the motor vehicle is in operation exhaust gas 32 flows from the combustion engine via the inlet opening 22 into the silencer 10. The exhaust gas 32 flows through the silencer 10 in the flow direction S and is conducted via the outlet opening 26 into an outlet pipe 34 of the exhaust gas system, which for example opens into an exhaust pipe of the motor vehicle.

In the process, the silencer chamber 16 is formed by the outer casing 28 as well as the two end walls 20, 24 which delimit the silencer chamber 16.

This means that the silencer chamber 16 extends in the flow direction S from the upstream end wall 20 to the downstream end wall 24 and thus substantially over the whole silencer 10 in this direction.

The filter 14 has a separate monolith housing 36, in which a filter monolith 38 through which exhaust gas can flow in the flow direction S is accommodated (see FIG. 2).

The filter 14 is, for example, a catalytic converter, a diesel particulate filter (DPF), a gasoline particulate filter (GPF) or a combination thereof.

The filter monolith 38 has a circular cylindrical shape. However, in principle, the filter monolith 38 can essentially have any design.

The monolith housing 36 comprises a housing outer casing 40, which fully radially surrounds the filter monolith 38 in circumferential direction U, as well as an upstream, conical end wall 42 and a downstream, conical end wall 44, which each delimit the filter monolith 38 in the axial direction.

The upstream, conical end wall 42 has a first opening 46, via which the filter 14 is coupled in terms of flow to the inlet opening 22 by a first exhaust gas line 48. Further, the upstream, conical end wall 44 has a second opening 50, via which the filter 14 is coupled in terms of flow to the outlet opening 26 by a second exhaust gas line 52.

In the process, the first exhaust gas line 48 extends uninterrupted, i.e. axially and circumferentially closed, from the inlet opening 22 to the first opening 46.

The second exhaust gas line 52 extends from the second opening 50 broken into sections to the outlet opening 26.

In the embodiment represented, the first exhaust gas line 48 and the second exhaust gas line 52 have a smaller diameter than the filter monolith 38 and the housing outer casing 40. In the process the conical end walls 42, 44 each form a transition between the different diameters of the exhaust gas lines 48, 52 and the housing outer casing 40.

In principle, in a further embodiment the filter monolith 38 and/or the monolith housing 36 can essentially have any design.

The silencer 10 further comprises several perforated partitions 54, which are arranged at a distance from one another in the flow direction S in the housing interior 18, and divide the silencer chamber 16 into several adjacent silencer subchambers 56 in the flow direction S.

The partitions 54 extend radially relative to the flow direction S from the outer casing 28 to the components guiding the exhaust gas in the housing interior 18, which in this embodiment are formed by the second exhaust gas line 52.

In the process, the partitions 54 extend over the whole cross-section surface between the second exhaust gas line 52 and the outer casing 28, with the result that the silencer subchambers 56 are separated from one another by the partitions 54 and are coupled to one another in terms of flow only via the perforation 58 in the partitions 54 and/or by the perforation 58 of the second exhaust gas line 52.

In the process, the second exhaust gas line 52 extends in sections in each case through several partitions 54 adjacent to one another in the flow direction S and the silencer subchamber 56 lying in between.

Exhaust gas does not flow through the silencer subchambers 56 and thus the silencer chambers, rather they serve as Helmholtz chambers, in which gas merely pulses.

The second exhaust gas line 52 is perforated in sections, in the sections which border silencer subchambers 56, with the result that when the motor vehicle is in operation the exhaust gas 32 flowing through the second exhaust gas line 52 is coupled in terms of flow to the corresponding bordering silencer subchambers 56 via the perforation 58.

The silencer 10 comprises partitions 54 with different contours, whereby the silencer 10 has segments 60, 61, 62 adjacent to one another in the flow direction S, with differently formed cross sections perpendicular to the flow direction S.

In the process each segment 60, 61, 62 comprises in each case three partitions 54 or two partitions 54 and an end wall 20, 24, which have the same contour. Thus, each segment 60, 61, 62 comprises two silencer subchambers 56 with a constant cross section.

The silencer 10 has funnel-shaped connecting segments 64, 65, which each connect two segments 60, 61, 62 adjacent to one another in the flow direction S and with differently formed cross sections to one another in terms of flow.

The partitions 54 can have essentially any contours, but noncircular, oval or circular contours are preferred.

Further, the distances in the flow direction S between adjacent partitions 54 can be of different sizes.

Furthermore, the central axes of different segments 60, 61, 62 can be arranged in different ways, in particular offset with respect to one another.

In a further embodiment, the silencer 10 can have any number of silencer subchambers 56, segments 60, 61, 62 as well as connecting segments 64, 65.

The size and shape of the silencer 10 is preferably adapted to the installation space present in the motor vehicle and the volumes of the silencer subchambers 56 and to the silencing of the exhaust gas 32 to be achieved.

The silencer subchambers 56 are empty resonator chambers in this embodiment. This means that the silencer 10 is a resonance silencer.

Alternatively, the silencer 10 can be a reflective silencer or an absorptive silencer. Further, the silencer 10 can be a silencer in which the operating principles of the abovenamed silencer types are combined.

In an alternative embodiment, any number of the silencer subchambers 56 can be filled with an insulating material, in particular a sound-absorbing material, and/or exhaust gas does not flow through them.

As represented in FIG. 2, the outer casing 28 is divided into several interconnected individual segments 66, 67, 68, which are each allocated to a silencer subchamber 56 and thus form the section of the outer casing 28 for the corresponding silencer subchambers 56.

In each case, two individual segments 66, 67, 68 adjacent to one another of silencer subchambers 56 adjacent to one another in the flow direction S, as well as the partition 54 which separates the corresponding two silencer subchambers 56, are attached tightly and securely to one another by an attachment interface 72 at a connection point 70 running fully around in the circumferential direction U.

The individual segments 66, 67, 68 adjacent to one another and the partition 54 are, for example, welded together in three layers.

Thus, the attachment interface 72 here is a weld seam which extends through the three layers, formed from the individual segments 66, 67, 68 adjacent to one another and the partition 54, and in this way connects them together in a material-bonded manner.

Analogously, but only in two layers, the end walls 20, 24 are connected radially outside at the corresponding axial ends 74, 75 of the outer casing 28 to the outer casing 28.

Radially inside, the upstream end wall 20 is welded to the first exhaust gas line 48 and thus fully connected tightly and securely in the circumferential direction U to the first exhaust gas line 48.

The downstream end wall 24 as well as the partitions 54 are each welded radially inside to the second exhaust gas line 52 and thus fully connected tightly and securely in the circumferential direction U to the second exhaust gas line 52.

In an alternative embodiment, the end walls 20, 24 and/or the partitions 54 can be attached substantially in any way to the outer casing 28 and/or the first exhaust gas line 48 or the second exhaust gas line 52, in particular by seaming, welding or soldering for example.

In addition or alternatively, the individual segments 66, 67, 68 and the partitions 54 can each be interconnected in two layers.

Further, the partitions 54 can be attached only in sections to the outer casing 28 and/or the second exhaust gas line 52 in the circumferential direction U. This is the case in particular when the perforation 58 extends up to the inner and/or outer edge of the partition 54 and thus up to the outer casing 28 and/or the second exhaust gas line 52.

In an alternative embodiment, the outer casing 28 can be formed in one piece or have any number of individual segments 66, 67, 68. In particular, the outer casing 28 can have a number of individual segments 66, 67, 68 which corresponds to the number of segments 60, 61, 62, as well as the number of connecting segments 64, 65, wherein each of these segments 60, 61, 62, 64, 65 is allocated a corresponding individual segment 66, 67, 68.

In addition or alternatively, one or more partitions 54 can be provided at points in the housing interior 18 at which no individual segments 66, 67, 68 border one another.

In these cases, the partitions 54 are connected tightly and securely to the outer casing 28 radially outside on the inside 76 of the outer casing 28, in particular in a material-bonded manner as well as preferably fully in the circumferential direction U.

Further, individual partitions 54 can also be attached only radially outside to the outer casing 28 and/or radially inside to the second exhaust gas line 52.

In the embodiment represented, the filter 14 is arranged radially within the silencer subchamber 56 bordering the upstream end wall 20 fully inside the housing interior 18 and delimits it radially to the inside. In this way, the filter 14 is surrounded fully in the circumferential direction U as well as partially in the axial direction by the adjoining silencer subchamber 56.

In an alternative embodiment, the filter 14 can be arranged in principle in any silencer subchamber 56. In addition, or alternatively, the filter 14 can be accommodated only in sections, i.e. not fully, in a silencer subchamber 56 and/or extend through several silencer subchambers 56.

In the process, the filter 14 can be arranged at any point within the silencer subchamber 56 adjoining the upstream end wall 20 and/or in the housing interior 18.

When the motor vehicle is in operation, the exhaust gas 32 flows through the silencer 10 from the inlet opening 22 via the first exhaust gas line 48 first through the filter monolith 38 and then via the second exhaust gas line 52 through the silencer chamber 16 to the outlet opening 26. Here, the exhaust gas 32 is treated or filtered in the filter monolith 38 and then silenced via the coupling to the silencer subchambers 56.

In the embodiment represented, the second exhaust gas line 52 extends from the filter 14 closed, i.e. without perforation 58, through the partition 54 adjoining the filter 14 into the second silencer subchamber 56 adjacent in the flow direction S to which the second exhaust gas line 52 is coupled in terms of flow via the perforation 58. The exhaust gas 32 is hereby coupled in terms of flow to the silencer subchamber 56 which surrounds the filter 14 only via the second silencer subchamber 56.

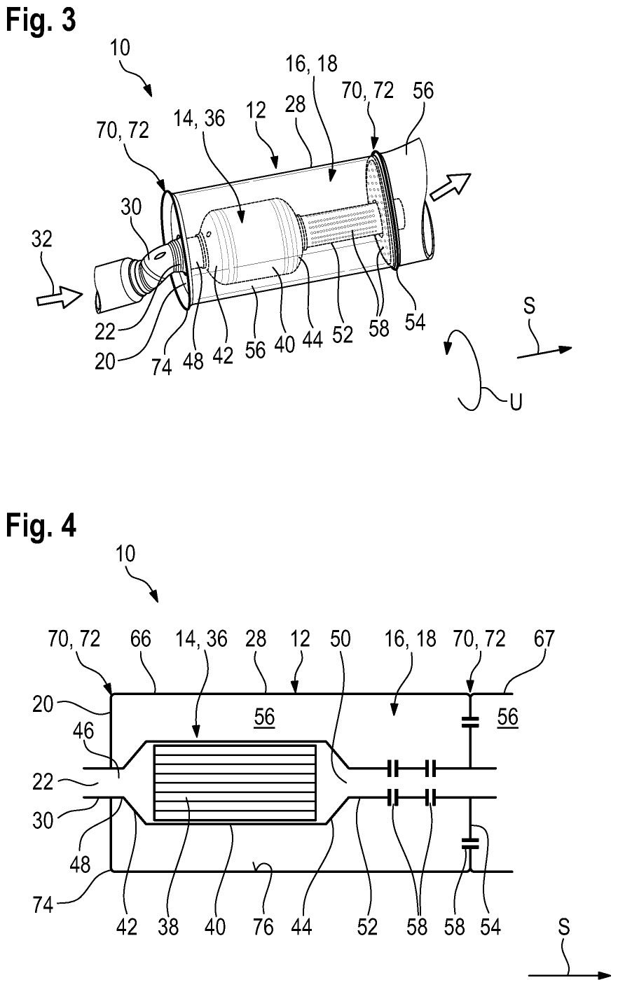

Silencers 10 according to further embodiments are now described with reference to FIGS. 3 to 7. For the components that are known from the above embodiment, the same reference numbers will be used and reference is made in this respect to the previous statements.

A silencer 10 according to a second embodiment is described in FIGS. 3 and 4.

In this embodiment, the second exhaust gas line 52 is perforated in its section between the filter 14 and the adjoining partition 54, with the result that the exhaust gas 32 is coupled in terms of flow directly via the perforation 58 to the silencer subchamber 56 surrounding the filter 14.

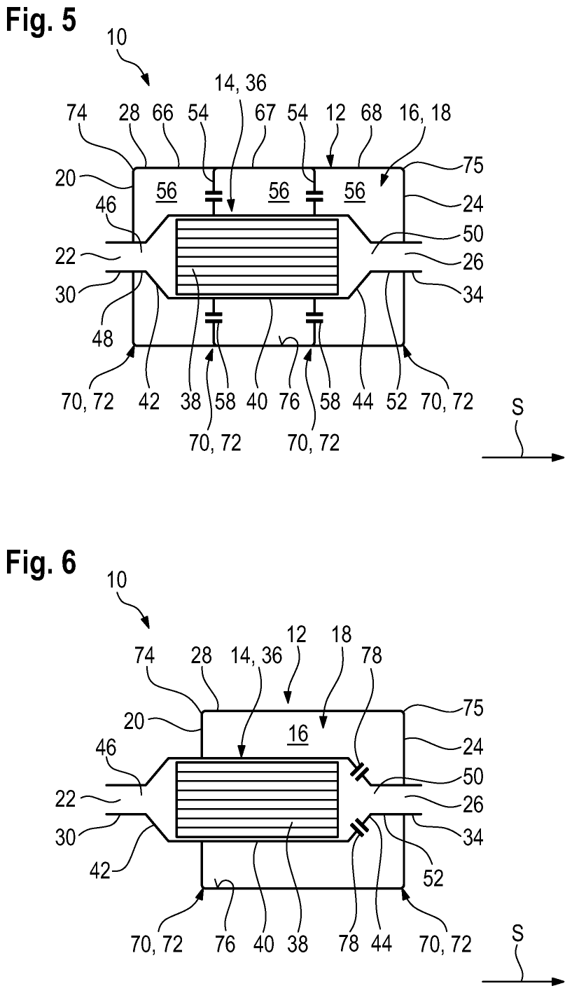

A silencer 10 according to a third embodiment is shown in FIG. 5, in which the filter monolith 38 as well as the monolith housing 36 extend through several silencer subchambers 56.

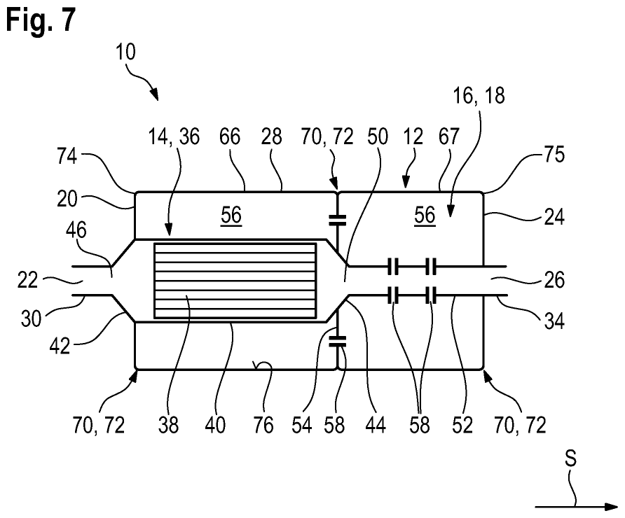

In the process the partitions 54 are attached radially inside to the housing outer casing 40.

Whereas in the embodiments represented in FIGS. 1 to 5 the filter 14 is in each case fully accommodated in the housing interior 18, in the following embodiments represented in FIGS. 6 and 7 the filter 14 is arranged merely in sections in the housing interior 18. This means that the filter 14 and its filter monolith 38 project partially out of the external housing 12.

In these cases, the inlet opening 22 of the silencer 10 is formed by the monolith housing 36 and the first exhaust gas line 48 is dispensed with.

A silencer 10 according to a fourth embodiment is shown in FIG. 6, in which the filter monolith 38 extends against the flow direction S through the upstream end wall 20 out of the external housing 12.

In the process the upstream end wall 20 is attached radially inside to the housing outer casing 40.

Further, the downstream, conical end wall 44 of the monolith housing 36 has several openings 78, via which the exhaust gas 32 flowing out of the filter monolith 38 during operation, is directly coupled to the silencer chamber 16 in terms of flow.

A silencer 10 according to a fifth embodiment is shown in FIG. 7, in which the monolith housing 36 extends against the flow direction S through the upstream end wall 20 out of the external housing 12, wherein however the filter monolith 38 is arranged fully in the housing interior 18.

In the process the upstream end wall 20 is attached radially inside to the housing outer casing 40.

In an alternative embodiment, the end wall 20 can be attached radially inside to the upstream conical end wall 42.

The perforated partition 54 is attached radially inside to the downstream conical end wall 44 of the monolith housing 36.

In all the embodiments described above, the silencer 10 can have further silencer subchambers 56, which follow the represented silencer chamber 16, in particular in the flow direction S.

The advantage of the silencer 10 described above is that the filter 14 is arranged at least in sections in the housing interior 18 of the silencer 10. In this way, the exhaust gas system of the motor vehicle can be designed particularly compact.

Further, the volume of the housing interior 18 is utilized efficiently in that the filter 14 is surrounded by the silencer chamber 16.

Furthermore, through the segmented design of the silencer 10, the installation space available in the motor vehicle can be utilized efficiently, with the result that the silencer 10 can have a particularly high-performance design.

The invention is not limited to the embodiments shown. In particular, individual features of an embodiment can be combined in any way with other features independently of the other features of the corresponding embodiment. The motor vehicle according to the invention can have one or more of the silencers 10 according to the invention.

Although embodiments have been disclosed, a worker of ordinary skill in this art would recognize that certain modifications would come within the scope of this invention. For that reason, the following claims should be studied to determine the true scope and content of this invention.

1. A silencer for an exhaust gas system of a motor vehicle comprising:
an external housing having at least one inlet opening and at least one outlet opening for exhaust gas;
a silencer chamber; and
a filter monolith through which exhaust gas flows, wherein the filter monolith is circumferentially surrounded by the silencer chamber.

2. The silencer according to claim 1, wherein the filter monolith is arranged fully within the silencer chamber.

3. The silencer according to claim, wherein the silencer comprises an upstream end wall having the at least one inlet opening and a downstream end wall having the at least one outlet opening, as well as an outer casing which extends from the upstream end wall to the downstream end wall to connect the upstream end wall to the downstream end wall.

4. The silencer according to claim 3, wherein the silencer chamber is delimited on one side by the upstream end wall and/or the downstream end wall, and on the other side by the outer casing.

5. The silencer according to claim 3, wherein a first exhaust gas line extends at least from the at least one inlet opening into a housing interior and/or a second exhaust gas line extends at least in sections from a filter including the filter monolith to the at least one outlet opening, and wherein the first exhaust gas line extends through the upstream end wall and the second exhaust gas line extends through the downstream end wall.

6. The silencer according to claim 5, wherein the silencer chamber is divided into several silencer subchambers, wherein the second exhaust gas line runs through a plurality of the several silencer subchambers and is broken into sections.

7. The silencer according to claim 5, wherein the second exhaust gas line is open to the silencer chamber via a perforation.

8. The silencer according to claim 1, wherein the filter monolith is surrounded circumferentially and on an end by a monolith housing and is accommodated in the monolith housing, wherein the at least one inlet opening is directly coupled in terms of flow to an interior of the monolith housing, such that exhaust gas first flows into the monolith housing before reaching the silencer chamber.

9. The silencer according to claim 8, wherein the second exhaust gas line proceeds from the monolith housing and guides gas from the monolith housing to the at least one outlet opening.

10. The silencer according to claim 9, wherein the monolith housing has an upstream conical end wall and a downstream conical end wall, and wherein the second exhaust gas line proceeds from the downstream conical end wall and the downstream conical end wall has additional openings at a distance from the second exhaust gas line, which open into the silencer chamber.

11. The silencer according to claim 1, wherein the silencer chamber is divided into silencer subchambers by at least one perforated radial partition.

12. The silencer according to claim 11, wherein the at least one perforated radial partition or one of several perforated radial partitions is attached radially outside to an outer casing of the external housing and radially inside to a monolith housing, in particular to an outer casing of the monolith housing or to an exhaust-gas-side, conical end wall of the monolith housing or to an exhaust gas line which proceeds from the monolith housing and guides gas out of the monolith housing to the at least one outlet opening.

13. The silencer according to claim 11, wherein the external housing of the silencer has an outer casing, which is composed of several individual segments attached to one another, wherein the individual segments are allocated to the silencer subchambers, in particular each silencer subchamber has its own individual segment.

14. The silencer according to claim 13, wherein the at least one perforated radial partition, preferably all perforated radial partitions, is attached to the outer casing in the region of an attachment of adjacent individual segments, in particular by the same attachment interface with which the adjacent individual segments are attached to one another, such that the attachment interface connects three parts to one another.

15. The silencer according to claim 10, wherein an end wall of the external housing is attached radially inside to a conical end wall of the monolith housing or to an outer casing of the monolith housing.

16. The silencer according to claim 1, wherein the silencer chamber is an empty resonator chamber or is filled with insulating material and preferably does not have exhaust gas flowing through the silencer chamber.

17. A motor vehicle with at least one silencer according to claim 1.
